(19) United States
(12) Patent Application Publication
(10) Pub. No.: US 2008/0125208 A1
(43) Pub. Date: May 29, 2008

(54) System and method for displaying gaming machine results

(76) Inventor: David B. Waters, Piedmont, SC (US)

Correspondence Address: MCNAIR LAW FIRM, P.A., P.O. BOX 10827, GREENVILLE, SC, 29603-0827, US

(21) Appl. No.: 11/983,938

(22) Filed: Nov. 13, 2007

Related U.S. Application Data
(63) Continuation-in-part of application No. 11/494,298, filed on Jul. 27, 2006.
(60) Provisional application No. 60/858,623, filed on Nov. 13, 2006.

(51) Int. Cl. A63F 13/00

(52) U.S. Cl. 463/19

(57) ABSTRACT

Virtual electronic bingo play comprising a computer readable medium having computer readable game play instructions for playing electronic bingo and having game play results; a display in electronic communications with the computer readable medium; a set of symbol information stored in the computer readable medium representing symbols displayed on the display; and a set of computer readable display instructions embodied in the computer readable medium for displaying a virtual symbol path on the display, receiving the game play results from the computer readable game play instructions, selecting symbol information from the set of symbol information according to the game play results, determining a location for placement of each symbol represented in the selected symbol information on the virtual symbol path according to the game play results and displaying the selected symbols at the determined locations along the virtual path so that the game play results are displayed to the player.

### CROSS-REFERENCE TO RELATED APPLICATION

This application is a continuation-in-part of nonprovisional patent application Ser. No. 11/494,298, filed Jul. 27, 2006, and also claims priority on U.S. Provisional Patent Application No. 60/858,623, filed Nov. 13, 2006.

### FIELD OF THE INVENTION

This invention is directed to a system and method for displaying gaming machine results, and more particularly, for displaying gaming machine results without using the traditional slot machine reels to provide a more innovative representation of gaming results.

### INCORPORATION BY REFERENCE

This application incorporates in its entirety United States Patent Application Publication 2007/0043584, published Feb. 22, 2007, entitled Electronic Game and Method of Playing Bingo.

### BACKGROUND OF THE INVENTION

In the casino industry, slot machines have been in place for many decades. The original slot machines were mechanical and based upon their internal workings, reels would spin by pulling an actuating arm and figures on the reels, once the reels stopped, would line up to show whether prizes were won or not. Historically, these were called “one-armed bandits” and were popular in locations such as Las Vegas, Atlantic City, and casinos in general. With the improvements in technology, mechanical reels, while still in use, have principally been replaced by electronic displays which display animated rotating reels that emulate the mechanical reels originally used. This allows the gaming machine manufacturers to take advantage of new technologies for random number generators, and other internal workings of the gaming machine done mechanically, but to maintain the appearance of spinning reels from which the machines were known. The traditional games used three or five reels which spin vertically to have symbols located on the reels align representing prizes won by the player.

With the widespread use of computers and animation, the player can lose interest in losing reels, whether mechanical or animated, as these have become so commonplace that merely changing the symbols on the reels no longer sufficiently distinguishes one gaming machine from another. Manufacturers have gone to great lengths to decorate their machines in order to attract players by distinguishing over other gaming machines through the appearance of aesthetics of the game. For example, gaming machines have incorporated themes and have used licensed logos and images to attempt to attract players and distinguish over other gaming machines. However, the principal operation of the game still remains to be mechanical or displayed vertically rotating reels.

Therefore, there is a need for a method of displaying gaming results which distinguishes over mechanical reels and provides for increased animation in order to attract players and distinguish over gaming machines.

### SUMMARY OF THE INVENTION

The above objectives are accomplished according to the present invention by a system for visualizing electronic bingo play without the need for physical or virtual reels comprising a computer readable medium having computer readable game play instructions for playing electronic bingo and having game play results; a display in electronic communications with the computer readable medium; a set of symbol information stored in the computer readable medium representing symbols displayed on the display; and a set of computer readable display instructions embodied in the computer readable medium for displaying a virtual symbol path on the display, receiving the game play results from the computer readable game play instructions, selecting symbol information from the set of symbol information according to the game play results, determining a location for placement of each symbol represented in the selected symbol information on the virtual symbol path according to the game play results and displaying the selected symbols at the determined locations along the virtual path so that the game play results are displayed to the player without the need for physical or virtual reels. The system wherein the computer readable display instructions include instructions for determining a winning symbol group according to the game play instructions and animating at least one of the displayed symbols of the winning symbol group on the display so that the user can see the pattern of displayed symbols needed for the winning symbol group. The system including a player control for receiving input from a player wherein the player control is in communications with the computer readable display medium; and a set of computer readable display instructions includes instructions for displaying a bonus icon on the display, receiving player input icon location selection information from the player control, moving the icon on the display according to the player input icon location selection information, determining a bonus amount according to the player input icon location selection information and the game play instructions, and displaying the determined bonus amount to the player. The system wherein the set of computer readable display instructions for determining a bonus amount according to the player input icon location selection information and the game play instructions includes instructions for selecting the bonus amount from a set of bonus amounts stored in the computer readable medium. The system wherein the computer readable display instructions includes instructions for organizing at least two of the symbols into a pattern representing a winning symbol group pattern according to the game play results. The system wherein the computer readable display instructions includes instructions for displaying a bet line on the display according to the game play instructions. The system wherein the virtual symbol path is displayed as a contiguous path.

### DESCRIPTION OF THE DRAWINGS

The invention will more readily be understood by referring to the following specification and drawings.

FIG. 1 is a representation of the display of the invention;

FIG. 2 is a representation of the display of the invention;

FIG. 3 is a diagram of the hardware used in the invention;

FIG. 4 is a flowchart describing the operation of the invention;

FIG. 5 is an illustration of a display of the invention;

FIG. 6 is a reproduction of a display of the invention;

FIGS. 7A and 7B are reproductions of displays of the invention; and,

FIG. 8 is a reproduction of a display of the invention.

### DESCRIPTION OF THE INVENTION

An object or module is a section of computer readable code embodied in a computer readable medium. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

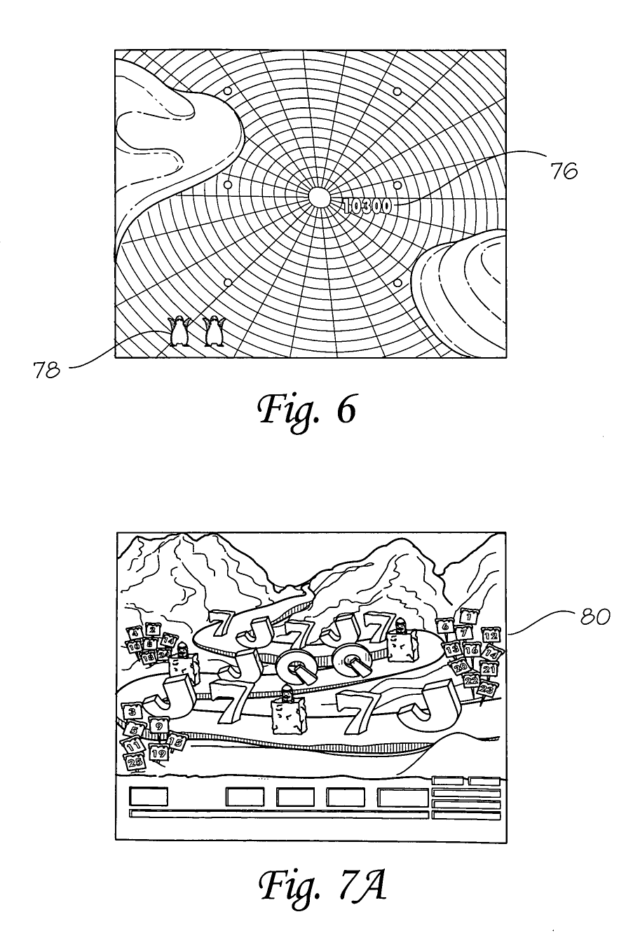

Referring now to FIG. 6, display 22 is shown representing a computer animated display for the viewer. The display is carried by a game terminal which is placed on a casino floor allowing players to play the game.

A virtual symbol path 12 is shown displayed allowing a plurality of symbols to be displayed traveling along the virtual symbol path in response to a player playing the game. When the symbols stop along the virtual symbol path in one embodiment, they are arranged generally in three rows of five symbols. Based upon the arrangement of the symbols, also as known as the winning symbol group, the player can be informed what prizes, if any, the player has won. Various winning symbol groups can correspond to different prizes.

In one embodiment, the invention is used to display intermediate prizes awarded when playing electronic bingo. The bingo game can be played by several players on separate game terminals that are in communications such as with a computer network. Once the bingo game begins, there are virtual bingo balls that “drop” and when a closing pattern is reached, the game can be won by a player. Additionally, intermediate prizes can be awarded prior to the game ending and such intermediate prizes can be represented by a winning symbol group.

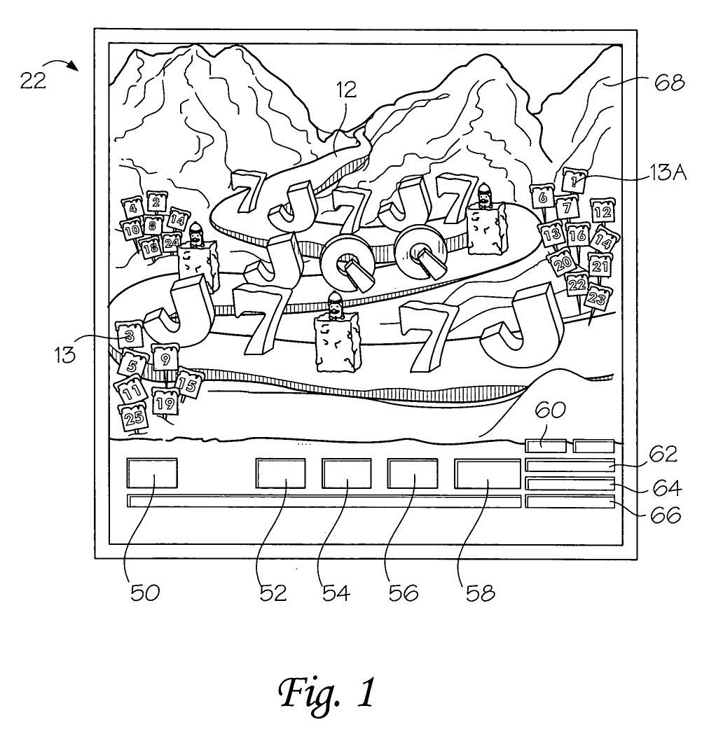

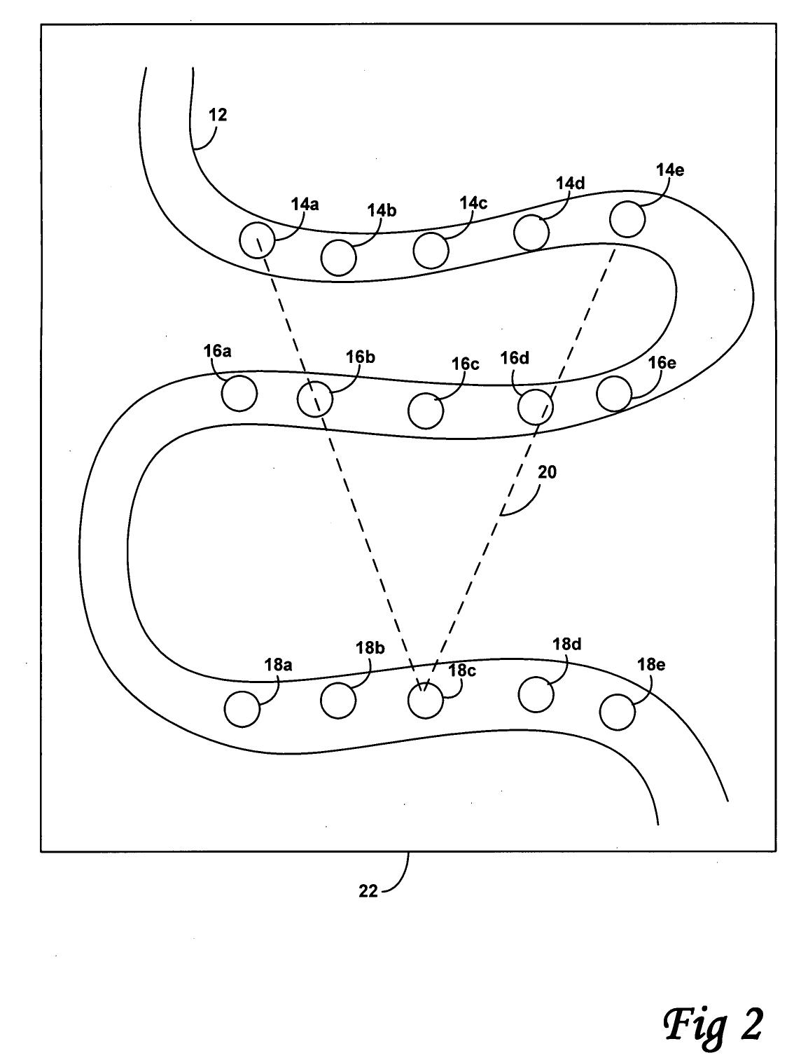

Referring to FIG. 1, indicators 13 shown numbered between 1 and 25 allow for the player to bet along 25 different bets. The player can deposit sufficient credits according to the bet or bets selected. For example, selecting indicator designated 1, shown as 13a, shows the winning symbol group in configuration 20 (FIG. 2), thereby showing the player that he has won along bet line 1.

Player controls 50, 52, 54, 56, 58, 60, 62, 64 and 66 can be used to provide player input to the game. Computer readable instructions can receive player input and respond according to the computer readable game play instructions. For example, player control 50 can be for providing player input that the player wishes to bet the maximum allowable amount. Player control 52 may correspond to a DAUB function as used in electronic bingo and player control 58 may correspond to player input representing that the player wishes to claim a prize that has been won. Further, player controls can be used to move icon 88 (FIG. 8) around the display during a bonus round. It should also be noted that player controls can be implemented through touch screen technology.

Referring now to FIG. 2, the virtual symbol path 12 is shown having symbols 14a through 14e in a first row, 16a through 16e in a second row, and 18a through 18e in a third row. When bet 1 has symbols aligned in a configuration shown as 20, a prize can be awarded. In configuration 20, symbols 14a, 16b, 18c 16b, and 14e are shown generally in a v-shape represented by line 20 and based upon the symbols displayed, can represent a win for the player. The v-shape is a winning symbol group pattern which allows the player to see what prizes, if any, the player has won according to the game play results from the computer readable medium. By allowing these symbols to travel down path 12, there is no display of reels, but the player can still be shown the animated representation of winning without using traditional reels.

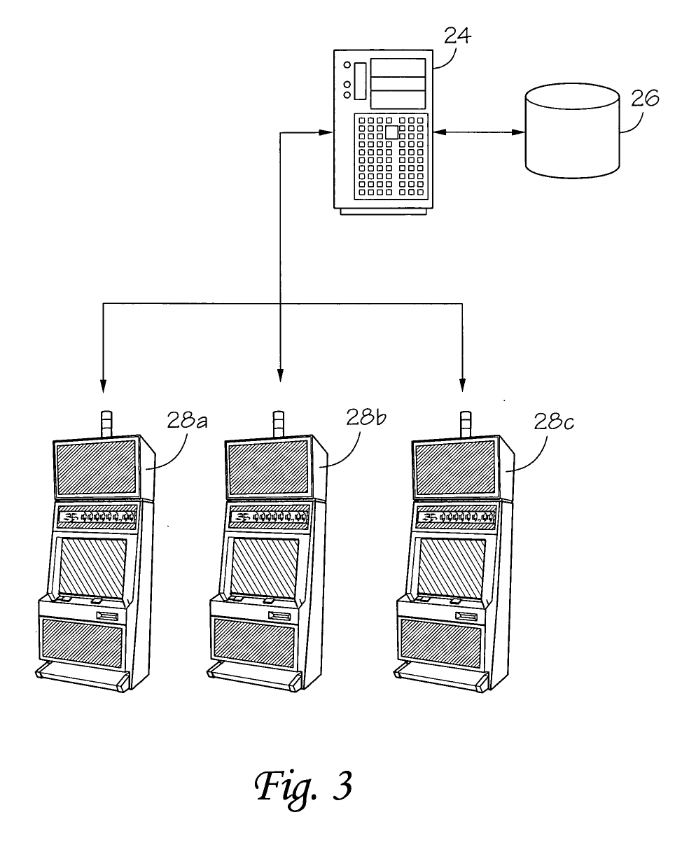

Referring now to FIG. 3, a server 24 with computer readable medium 26 is shown. In one embodiment, the computer readable game play instructions which drive the play of the game to produce a game play result are located on game computer readable medium 26 and executed by server 24. When the game play results are determined by server 24, this information is sent to gaming machines 28a, 28b, and 28c so that the gaming machines can display the appropriate symbols which travel along the virtual symbol path and represent what the player has won. Therefore, in this embodiment, a set of game play instructions embodied in game computer readable medium 26 can send game play results to terminal computer readable medium 28a. A set of computer readable display instructions can then display symbols from symbol information stored in the terminal computer readable medium.

In an alternate embodiment, the computer readable instructions which drive the play of the game are located on computer readable medium 26 executed by the individual gaming machines 28a, 28b, and/or 28c. In this embodiment, the gaming machines each include computer readable medium and computer readable instructions thus allowing the gaming machines to execute the computer readable instructions and display the appropriate symbols to represent what the player has won, without the need of server 24.

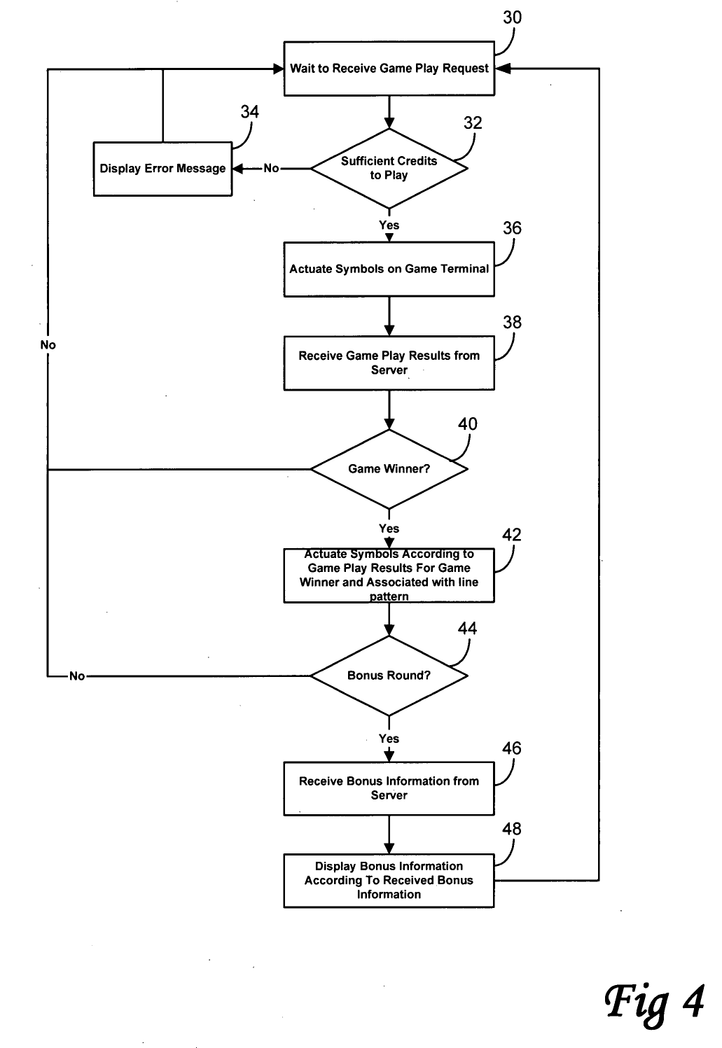

In an alternative embodiment, the computer readable instructions which drive the play of the game can be located on computer readable medium 28a along with the computer readable display instructions. Referring to FIG. 4, computer readable instructions wait to receive a game play request at step 30. If there are sufficient credits to play the game at step 32, the symbols are actuated on game terminal at step 36. This step is where the game is in progress and the results have not been displayed to the user. In step 38, the game play results are received from the server by the game terminal and a determination is made at step 40 is there is a game winner. If there is a game winner, the symbols are actuated on the display according to the game play results and associated with a line pattern in step 42 to inform the user that there has been a win. Selected symbol information representing symbols to be displayed can be stored at the terminal computer readable medium.

A determination is made if there is a bonus round in step 44, and if there is, the bonus information is received from the server at step 46, and the bonus information is displayed at step 48. In step 42, if there are not sufficient credits to play, an error message is displayed in step 34 and the process returns to step 30. In step 44, if there is no bonus round, the process returns to step 30.

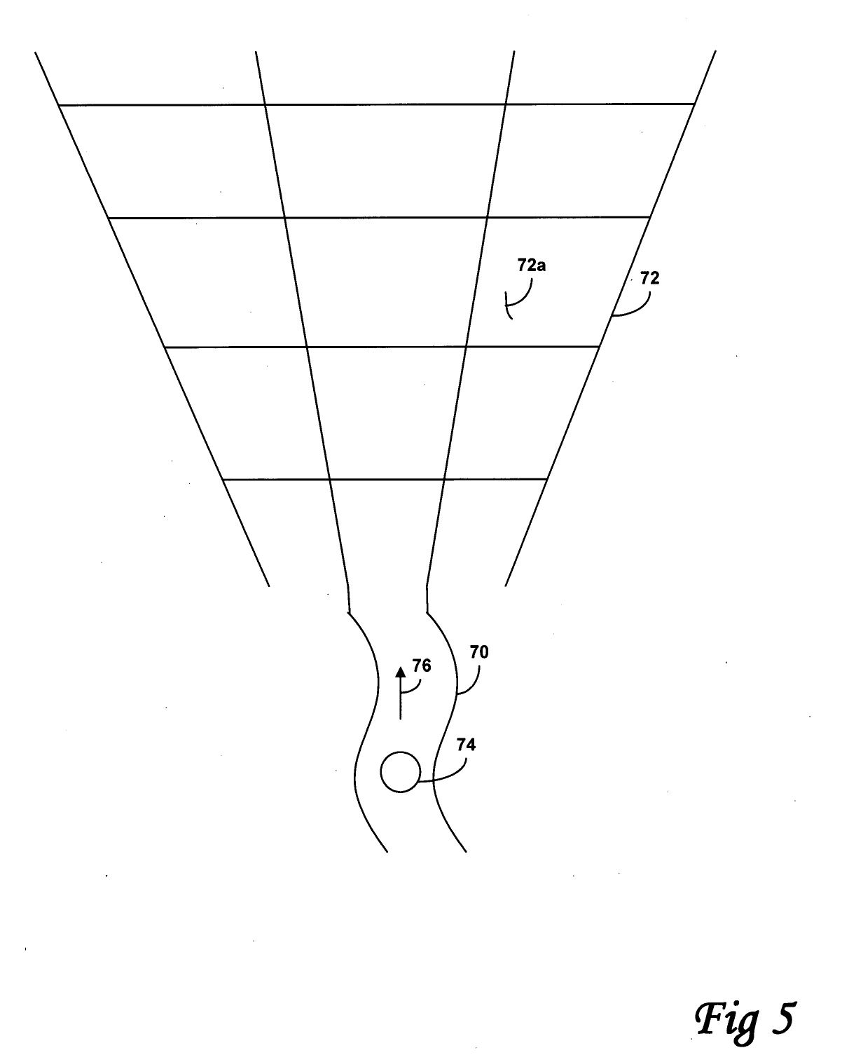

Referring now to FIG. 5, if there is a bonus round, an image is displayed representing an amount won by the bonus round. In one embodiment, a path 70 has an icon 74 which travels along the path in a direction 76. At the bottom of the path, the icon 74 lands in a predetermined location 72a of grid 72 and based upon where the icon lands, a bonus amount is awarded. Referring now to FIG. 6, icon 78 is shown showing that there are two icons left whereas the award amount in the section of the grid is shown as 76 representing the amount won by the bonus round.

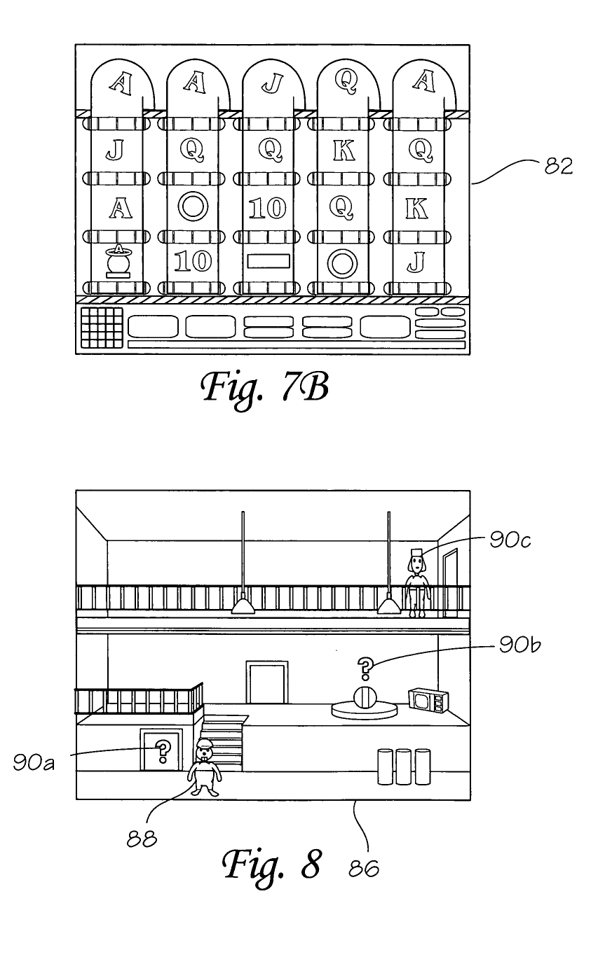

Referring now to FIGS. 7A and 7B, the display is shown as 80 in one embodiment having the virtual symbol path, the symbols, and the bet line. In this embodiment, the virtual symbol path is contiguous. In another embodiment, display 82 is shown having paths 84 which symbols travel along a plurality of symbol paths which for this embodiment travel from the top of display 82 to the bottom of display 82 along a plurality of paths.

In one embodiment, the bonus round shows a display 86. An icon 88 can be selected to move to a plurality of locations. For example, icon 88 can be selected to move to location 90a, 90b, or 90c. Based upon which location is selected, the bonus amount is awarded based upon the game play and is displayed on the screen to represent the amount won by the player. The location selections can be selected through a touch screen technology allowing the user to select each of the locations where the icon can be placed. Once the icon is placed in a specific location, the bonus can be determined according to the icon location selection information and the resulting bonus can be determined or selected from computer readable medium. The computer readable medium can have a set of bonus amounts which are pre-determined and can be selected according to player input received through the player control.

While a preferred embodiment of the invention has been described using specific terms, such description is for illustrative purposes only, and it is to be understood that changes and variations may be made without departing from the spirit or scope of the following claims.

What is claimed is:

1. A system for visualizing electronic bingo play without the need for physical or virtual reels comprising:
a computer readable medium having computer readable game play instructions for playing electronic bingo and having game play results;
a display in electronic communications with said computer readable medium;
a set of symbol information stored in said computer readable medium representing symbols displayed on said display; and,
a set of computer readable display instructions embodied in said computer readable medium for displaying a virtual symbol path on said display, receiving said game play results from said computer readable game play instructions, selecting symbol information from said set of symbol information according to said game play results, determining a location for placement of each symbol represented in said selected symbol information on said virtual symbol path according to said game play results and displaying said selected symbols at said determined locations along said virtual path so that said game play results are displayed to the player without the need for physical or virtual reels.

2. The system of claim 1 wherein said computer readable display instructions include instructions for determining a winning symbol group according to said game play instructions and animating at least one of said displayed symbols of said winning symbol group on said display so that the user can see the pattern of displayed symbols needed for said winning symbol group.

3. The system of claim 1 including:
a player control for receiving input from a player wherein said player control is in communications with said computer readable display medium; and,
said set of computer readable display instructions includes instructions for displaying a bonus icon on said display, receiving player input icon location selection information from said player control, moving said icon on said display according to said player input icon location selection information, determining a bonus amount according to said player input icon location selection information and said game play instructions, and displaying said determined bonus amount to the player.

4. The system of claim 3 wherein said set of computer readable display instructions for determining a bonus amount according to said player input icon location selection information and said game play instructions includes instructions for selecting said bonus amount from a set of bonus amounts stored in said computer readable medium.

5. The system of claim 1 wherein said computer readable display instructions includes instructions for organizing at least two of said symbols into a pattern representing a winning symbol group pattern according to said game play results.

6. The system of claim 1 wherein said computer readable display instructions includes instructions for displaying a bet line on said display according to said game play instructions.

7. The system of claim 1 wherein said virtual symbol path is displayed as a contiguous path.

8. A system for visualizing electronic bingo play without the need for physical or virtual reels comprising:
a game computer readable medium;
a set of game play instructions embodied in said game computer readable medium for playing electronic bingo and having game play results;
a terminal computer readable medium in communications with said game computer readable medium;
a display in electronic communications with said terminal computer readable medium;
a set of symbol information stored in said terminal computer readable medium representing symbols displayed on said display; and,
a set of computer readable display instructions embodied in said terminal computer readable medium for displaying a virtual symbol path on said display, receiving said game play results from said game play instructions, selecting symbol information from said set of symbol information according to said game play results, determining a location for placement of each symbol represented by said selected symbol information on said virtual symbol path according to said game play results and displaying said selected symbols at said determined locations along said virtual path so that said game play results are displayed to the player without the need for physical or virtual reels.

9. The system of claim 8 wherein said computer readable display instructions include instructions for determining a winning symbol group according to said game play instructions and animating at least one of said displayed symbols of said winning symbol group on said display so that the user can see the pattern of displayed symbols needed for said winning symbol group.

10. The system of claim 8 including:
a player control for receiving input from a player wherein said player control is in communications with said terminal computer readable medium; and,
said set of computer readable display instructions includes instructions for displaying a bonus icon on said display, receiving player input icon location selection information from said player control, moving said icon on said display according to said player input icon location selection information, determining a bonus amount according to said player input icon location selection information and said game play instructions, and displaying said determined bonus amount to the player.

11. The system of claim 10, wherein said set of computer readable display instructions for determining a bonus amount according to said player input icon location selection information and said game play instructions includes instructions for selecting said bonus amount from a set of bonus amounts stored in said computer readable medium.

12. The system of claim 8 wherein said computer readable display instructions includes instructions for organizing at least two of said symbols into a pattern representing a winning symbol group pattern according to said game play results.

13. The system of claim 8 wherein said computer readable display instructions includes instructions for displaying a bet line on said display according to said game play instructions.

14. The system of claim 8 wherein said virtual symbol path is displayed as a contiguous path.

15. A system for visualizing gaming machine play without the need for physical or virtual reels comprising:
a terminal computer readable medium in communications with a game play computer readable medium having a set of game play instructions having game play results;
a display in electronic communications with said terminal computer readable medium;
a set of symbol information stored in said terminal computer readable medium representing symbols displayed on said display; and,
a set of computer readable display instructions embodied in said terminal computer readable medium for displaying a virtual symbol path on said display, receiving said game play results from said game play instructions, selecting symbol information from said set of symbol information according to said game play results, determining a location for placement of each symbol represented by said selected symbol information on said virtual symbol path according to said game play results, and displaying said selected symbols at said determined locations along said virtual path so that said game play results are displayed to the player without the need for physical or virtual reels.

16. The system of claim 15 wherein said computer readable display instructions include instructions for determining a winning symbol group according to said game play instructions and animating at least one of said displayed symbols of said winning symbol group on said display so that the user can see the pattern of displayed symbols needed for said winning symbol group.

17. The system of claim 15 including:
a player control for receiving input from a player wherein said player control is in communications with said terminal computer readable medium; and,
said set of computer readable display instructions includes instructions for displaying a bonus icon on said display, receiving player input icon location selection information from said player control, moving said icon on said display according to said player input icon location selection information, determining a bonus amount according to said player input icon location selection information and said game play instructions, and displaying said determined bonus amount to the player.

18. The system of claim 17 wherein said set of computer readable display instructions for determining a bonus amount according to said player input icon location selection information and said game play instructions includes instructions for selecting said bonus amount from a set of bonus amounts stored in said computer readable medium.

19. The system of claim 15 wherein said computer readable display instructions includes instructions for organizing at least two of said selected symbols into a pattern representing a winning symbol group pattern according to said game play results.

20. The system of claim 15 wherein said computer readable display instructions includes instructions for displaying a bet line, on said display according to said game play instructions.

21. The system of claim 15 wherein said virtual symbol path is displayed as a contiguous path.
